(19) United States
(12) Patent Application Publication
(10) Pub. No.: US 2026/0338645 A1
(43) Pub. Date: Oct. 29, 2026

(54) STATION FOR AUTOMATIC DIAGNOSTICS OF ELECTRONIC GADGETS AND METHOD OF AUTOMATIC DIAGNOSTICS OF ELECTRONIC GADGETS

(71) Applicant: NEVA SYSTEMS LIMITED, Priory Hill Dartford Kent (GB)

(72) Inventors: Tyulkin Nikolay PAVLOVICH, Kaliningrad (RU); Grigorii GLAZMAN, Belgrade (RS)

(21) Appl. No.: 19/101,505

(22) PCT Filed: Aug. 5, 2022
(86) PCT No.: PCT/IB2022/000394

§ 371 Date: Feb. 5, 2025

(51) Int. Cl. G01M 99/00; G06F 3/0354

(52) U.S. Cl. CPC G01M 99/00; G06F 3/03545

(57) ABSTRACT

A group of inventions relates to means of automatic diagnostics of electronic gadgets and may be used in the electronics industry. The essence of the group of inventions is a station for automatic diagnostics of gadgets comprising a control unit to which a gadget communicator, gadget visual and hardware defects identification aids, and a gadget spatial orientation device capable of moving the gadget linearly relative to the defects identification aids are connected. The control unit has visual defects identification software, and the spatial orientation device has been designed with a capability of the gadget rotation relative to defect identification aids. The technical result, which the group of inventions aims to achieve, is to increase the number of detectable visual defects of a gadget by the station for automatic diagnostics (2 primary claims, 5 subclaims, 3 illustrations).

A group of inventions relates to means of automatic diagnostics of electronic gadgets and may be used in the electronics industry, and also for commercial purposes.

A station for automatic diagnostics of electronic gadgets and a method of automatic diagnostics of electronic gadgets by means of this station have been selected as a prototype. The station consists of a control unit to which an electronic gadget communicator, electronic gadget visual and hardware defects identification aids, and an electronic gadget spatial orientation device capable of moving the electronic gadget linearly relative to the electronic gadget visual and hardware defects identification aids are connected. The control unit has electronic gadget visual defects identification software, and the electronic gadget visual defects identifier is equipped with a camera that captures the electronic gadget appearance during diagnostics and sends electronic signals to the control unit. Herewith the method consists in positioning of an electronic gadget in the electronic gadget spatial orientation device of the station for automatic diagnostics of electronic gadgets, connecting the electronic gadget to the control unit of the station for automatic diagnostics of electronic gadgets via the electronic gadget communicator, moving the electronic gadget relative to the electronic gadget visual and hardware defects identification aids, capturing the electronic gadget appearance by means of the camera, sending electronic signals to the control unit, and identifying the electronic gadget visual and hardware defects by the control unit [U.S. Pat. No. 11,004,042B2, issue date: May 11, 2021; IPC: G06 10/00; H04 1/24; G07 17/00; H04M 1/72406].

The prototype disadvantage is an insufficiently high degree of identification of electronic gadget visual defects by the electronic gadget visual defects identifier because during the electronic gadget diagnostics the camera of the electronic gadget visual defects identifier does not capture all required angles, including the end, front, and back of the electronic gadget, at an equal distance, which is caused by the lack of designed rotational capability of the electronic gadget being diagnosed in the camera lens field of view, resulting in deterioration of the electronic gadget diagnostics quality and further accuracy of its residual value assessment. So there is a need to develop a station and technology using this station that provides this capability.

The technical issue, which the group of inventions aims to achieve, is to improve the quality of automatic diagnostics of electronic gadgets by the station for automatic diagnostics of electronic gadgets.

The technical result, which the group of inventions aims to achieve, is to increase the number of detectable visual defects of an electronic gadget by the station for automatic diagnostics of electronic gadgets.

An additional technical result, which the group of inventions aims to achieve, is to increase the number of detectable hardware defects of an electronic gadget by the station for automatic diagnostics of electronic gadgets.

An additional technical result, which the group of inventions aims to achieve, is to provide a possibility to assess the residual value of electronic gadgets being diagnosed by the station for automatic diagnostics of electronic gadgets.

An additional technical result, which the group of inventions aims to achieve, is to simplify the design of the electronic gadget spatial orientation device of the station for automatic diagnostics of electronic gadgets.

The essence of the first invention out of the group of inventions is as follows.

A station for automatic diagnostics of electronic gadgets consists of a control unit to which an electronic gadget communicator, electronic gadget visual and hardware defects identification aids, and an electronic gadget spatial orientation device capable of moving the electronic gadget linearly relative to the electronic gadget visual and hardware defects identification aids are connected. The control unit has electronic gadget visual defects identification software. Unlike the prototype, the electronic gadget spatial orientation device has been designed capable of rotating the electronic gadget relative to the electronic gadget visual and hardware defects identification aids.

The essence of the second invention out of the group of inventions is as follows.

A method of automatic diagnostics of electronic gadgets by a station for automatic diagnostics of electronic gadgets comprises positioning of an electronic gadget in the electronic gadget spatial orientation device of the station for automatic diagnostics of electronic gadgets, connecting the electronic gadget to the control unit of the station for automatic diagnostics of electronic gadgets via the electronic gadget communicator, moving the electronic gadget relative to the electronic gadget visual and hardware defects identification aids, and identifying the electronic gadget visual and hardware defects by the control unit. Unlike the prototype, when the electronic gadget is moved relative to the visual and hardware defects identification aids by means of the electronic gadget spatial orientation device, the electronic gadget is rotated relative to the electronic gadget visual and hardware defects identification aids.

The station for automatic diagnostics of electronic gadgets provides for positioning of an electronic gadget therein, connecting the electronic gadget to the station control unit, moving the electronic gadget relative to the visual and hardware defects identification aids, and identifying electronic gadget visual and hardware defects by the control unit. The station has a control unit, an electronic gadget communicator, electronic gadget visual and hardware defects identification aids, and an electronic gadget spatial orientation device. The station housing may be made of any structural material, inside which the above devices may be fixed, or they may be mounted on a solid surface. In this case, station assemblies will be oriented relative to each other in such a way as to provide the possibility of moving the electronic gadget relative to the visual and hardware defects identification aids.

The control unit comprises an input/output tool, an input/output interface, a computer module equipped with electronic gadget visual and hardware defects identification software tools.

The input/output tool enables a user-station interface by setting a diagnostics program and displaying the diagnostic results, and may be represented by a display, a keyboard, buttons, however, most preferably by a touch screen display.

Input and output interfaces allow connecting the station with the gadget being diagnosed and/or additional devices, such as printer, PC, etc.

Any known electrical connectors can be input and output interfaces.

The electronic gadget hardware defects identifier has electronic gadget hardware defects identification software.

The electronic gadget hardware defects identification software ensures assessment of operability of the electronic gadget hardware components and can be a combination of software and databases stored in the control unit internal memory, which send electronic signals to the electronic gadget being diagnosed to enable and disable its hardware components, receiving electronic signals from the electronic gadget being diagnosed after enabling and disabling the hardware components, comparing target values of the indicated signals that characterize efficient performance of the electronic gadget with those preset in the database, and drafting a conclusion about the electronic gadget hardware components performance based on the comparison results.

The hardware components under test may be electronic gadget modules such as Wi-Fi, Bluetooth, NFC, GPS, speaker, microphone, accelerometer, display, flash, and others. Additionally, the electronic gadget hardware defects identifier may include a camera focus test mark for diagnostics of the electronic gadget camera. The camera may be tested under different illumination conditions. In order to provide different illumination conditions, the control unit is designed so that it can change the brightness of the station interior lighting by changing the supplied lighting power or by other means.

The electronic gadget communicator contains an electrical connector, a conductive cable, and a rotary mechanism.

The rotary mechanism enables an electronic gadget to be locked in the electronic gadget spatial orientation device in such a way that it is limited in linear movement, but still retains the ability to rotate around its longitudinal axis.

Additionally, to improve the quality of hardware defects diagnostics by increasing the number of diagnosed hardware components, the electronic gadget hardware defects identifier may contain a stylus attached to the unit of the stylus positioning relative to the electronic gadget, which allows the station to diagnose the electronic gadget display performance.

The stylus may comprise a casing, a tip, and a connector to plug to the electronic gadget hardware defects identifier.

Additionally, the stylus may contain a casing with outer and inner movable rods inside, interacting with each other to enable diagnostics of a touch or press-sensitive display of the electronic gadget by applying a successively varying degree of pressure thereto. Hereby the inner rod is fixed in a cage, and its outer and inner ends are fitted with springs. The springs can be fastened coaxially to the rod or at an angle, and their cross-sectional diameter can be a fraction of that of the rod, or greater. In the most preferable option, however, the springs are mounted on the two opposite ends of the rod in line with the central axis of the stylus.

The unit of the stylus positioning relative to the electronic gadget may be configured to move in one, two or more planes and feature a carriage mounted on one or more guides for this purpose. It may also contain a stylus mount, guides, and actuators. In the most preferable option, the stylus positioning unit guides are fastened to the station housing parallel to the base so as to allow the stylus moving horizontally. In this case, the actuators can be servo, electric, hydraulic, pneumatic or any other known mechanisms and be fixed in such a way as to ensure the stylus movement in the horizontal and/or vertical planes.

The electronic gadget visual defects identifier is a combination of electronic gadget visual defects identification software, a camera, and station interior lighting.

The electronic gadget visual defects identification software provides for determination of the electronic gadget visual integrity and/or the degree of its damage and may represent a combination of software and a database. It provides for sending electronic signals to the camera to start shooting, receiving one or a series of images from the camera, detecting the electronic gadget mechanical damage on the images captured, classification of detected damages based on the values set in the database, and drafting a conclusion regarding the electronic gadget visual integrity and/or the degree of its damage.

The station camera enables acquiring an image of the electronic gadget being diagnosed and sending the acquired image to the electronic gadget visual defects identifier, and may contain one or more lenses and a connector to plug to the electronic gadget visual defects identifier.

The camera can be attached in any way and at any place of the station housing so that its lens field of view covers the electronic gadget located in the electronic gadget spatial orientation device.

The station interior lighting provides different illumination conditions for camera diagnostics by the electronic gadget hardware defects identifier on command from the control unit. It can be represented by any light source, but in the most preferable option, is a LED lamp or a system of LED lamps.

The electronic gadget spatial orientation device ensures the electronic gadget movement relative to the electronic gadget visual and hardware defects identification aids. It may contain a frame, a receiving slot, a swivel mechanism mount for the electronic gadget communicator, flaps, and a swivel-clamp assembly.

The receiving slot offers a possibility to accommodate an electronic gadget in the electronic gadget spatial orientation device and can be represented by a combination of a hole matching the size of the electronic gadget and any manipulator and/or conveyor.

However, in the most preferable option, the possibility of positioning an electronic gadget in the electronic gadget spatial orientation device is ensured by a retractable mechanism that enables moving the electronic gadget spatial orientation device outward from the station housing. The retractable mechanism may be represented by a telescopic mechanism, a conveyor or a manipulator.

In the most preferable option, however, the retractable mechanism has guides fitted with actuators. In this case, the actuators can be servo, electric, hydraulic, pneumatic or any other mechanisms known from the prior art and be fixed to the station housing in such a way as to allow the electronic gadget spatial orientation device moving horizontally.

Retaining the electronic gadget on the same level with the swivel-clamp assembly can be provided by any means known in the prior art, such as a manipulator. In the most preferred option, however, the retention is ensured by flaps forming a plane flush with the swivel-clamp assembly so as to enable easily securing the electronic gadget between the output plug of said device and the swivel-clamp assembly lock, acting on the electronic gadget mechanically.

Flaps can be made of any material and have any size and shape. However, in the most preferable option, they are set opposite each other and represent flat rectangular platforms with the width and length corresponding to the width and length of the electronic gadget, which provides a simplified design for the electronic gadget spatial orientation device. Also in the most preferable option, the flaps comprise guides fitted with flap actuators attached to the station housing so that the flaps can be moved vertically towards the station side panels.

The flaps may also have marks for the electronic gadget dimensioning through the control unit analysis of the electronic gadget image acquired by the station camera against these marks.

The swivel-clamp assembly allows for locking and orientation of the electronic gadget relative to electronic gadget visual and hardware defects identification aids and can be represented by any conveyor, manipulator, and/or system of pushers and carriages known in the prior art. However, in the most preferable option, the swivel-clamp assembly has a rod pusher with an internal spring and a pusher actuator, an electronic gadget retainer, and a rotary mechanism.

The electronic gadget retainer ensures the attachment of the electronic gadget and can be fitted with a plate with parallel protrusions matching the end part of the electronic gadget.

The rotary mechanism ensures that the electronic gadget rotates relative to electronic gadget visual and hardware defects identification aids and can be represented by any known swivel device. In the most preferable option, however, the rotary mechanism ensures that the electronic gadget rotates 0 to 360 degrees about its axis and comprises perpendicularly arranged spur gears provided with a drive gear actuator.

The control unit identifies electronic gadget visual and hardware defects and supports the electronic gadget diagnostics based on software and/or databases installed in the control unit internal memory or third-party software and/or databases. It is also possible to implement an option whereby the control unit contains a machine learning algorithm, including a neural network. It is also possible to implement an option whereby the software calculations during the electronic gadget diagnostics are performed on a remote server by means of cloud computing.

Furthermore, to enhance functions of the station, the control unit may be designed capable of evaluating the residual value of the electronic gadget being diagnosed by comparing the parameters determined by the device during identification of the electronic gadget visual and hardware defects with those preset in the database and related to residual value data of the electronic gadget. Furthermore, to enhance functions of the station, the control unit may be designed with a feature to reset the electronic gadget to its initial settings (factory parameters).

The group of inventions can be made from known materials using known tools, which evidences its compliance with the patentability criterion of “industrial applicability”.

The group of inventions is characterized by a combination of essential features unknown in the prior art, distinguished by the fact that:
The electronic gadget spatial orientation device has been designed capable of rotating the electronic gadget relative to the electronic gadget visual and hardware defects identification aids.
When the electronic gadget is moved relative to the visual and hardware defects identification aids by means of the electronic gadget spatial orientation device, the electronic gadget is rotated relative to the electronic gadget visual and hardware defects identification aids.

The combination of essential features of the invention allows the camera of the electronic gadget visual defects identifier to shoot from all required angles, including the end, front, and back of the electronic gadget, making it possible for the control unit to acquire and process more data on the electronic gadget apparent condition.

This results in achieving a technical result, which is to increase the number of detectable visual defects of an electronic gadget by the station for automatic diagnostics of electronic gadgets, thereby providing a high degree of identification of the electronic gadget visual defects by the electronic gadget visual defects identifier.

The group of inventions has a set of essential features unknown in the prior art, which indicates its compliance with the patentability criterion of “novelty”.

Stations for automatic diagnostics of electronic gadgets comprising a control unit to which an electronic gadget communicator, electronic gadget visual and hardware defects identification aids, and an electronic gadget spatial orientation device capable of moving the electronic gadget linearly relative to the electronic gadget visual and hardware defects identification aids are connected, are known in the prior art. The control unit has electronic gadget visual defects identification software.

However, stations in which the electronic gadget spatial orientation device is designed capable of rotating the electronic gadget relative to the electronic gadget visual and hardware defects identification aids are not known in the prior art.

Therefore, the invention meets the patentability criterion of “inventive step”.

The inventions out of the group of inventions are interrelated and form a single inventive concept that resides in implementing a method of automatic diagnostics of electronic gadgets by a station for automatic diagnostics of electronic gadgets, which indicates that the group of inventions meets the patentability criterion of “unity of invention”.

The group of inventions is explained by the following figures.

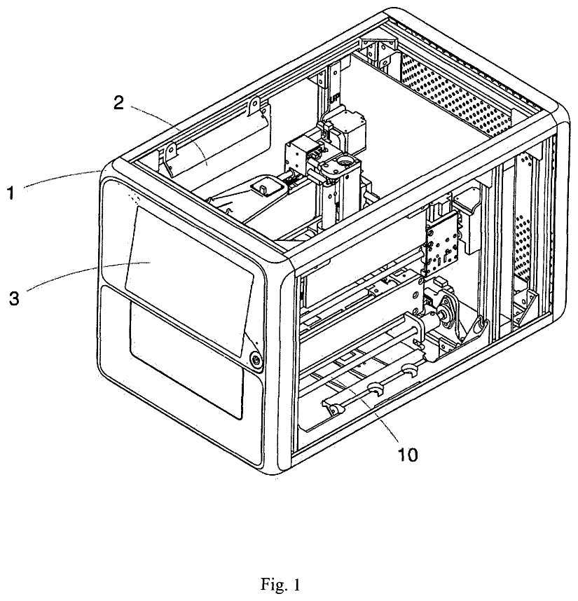

FIG. 1—Station for automatic diagnostics of electronic gadgets without housing panels. Isometric view.

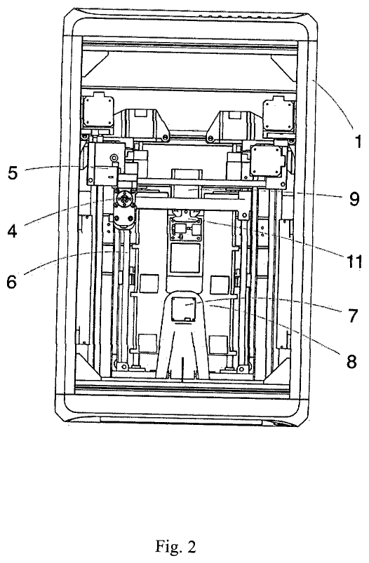

FIG. 2—Station for automatic diagnostics of electronic gadgets without housing panels. Top view.

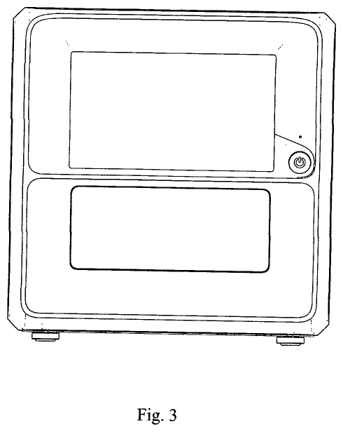

FIG. 3—Station for automatic diagnostics of electronic gadgets. Front view.

An option of the group of inventions, which may be amended or supplemented in any way, is given below to demonstrate the feasibility and better understanding of the essence of the group of inventions, whereby the present group of inventions is by no means limited by the option presented.

The station for automatic diagnostics of electronic gadgets has a housing inside which an electronic gadget communicator, electronic gadget visual and hardware defects identification aids, and an electronic gadget spatial orientation device are mounted.

Housing 1 contains skin panels with openings for input and output connectors and station controls, as well as a power supply plug. The housing interior also accommodates station interior lighting tool 2.

The control unit comprises input/output tool 3, an input/output interface, a computer module equipped with electronic gadget visual and hardware defects identification software tools.

The electronic gadget communicator contains an output plug, a conductive cable, and a rotary mechanism.

The electronic gadget hardware defects identifier is a combination of electronic gadget hardware defects identification software tool, an electronic gadget communicator, and stylus positioning assembly 4.

Stylus positioning assembly 4 contains stylus mount 5, guides 6, and actuators.

The stylus contains a casing with outer and inner movable rods inside, interacting with each other, a tip, a connector to plug to the electronic gadget hardware defects identifier, and stylus two-plane positioning unit 4. The inner rod is fixed in the cage, and its outer and inner ends are fitted with springs.

The electronic gadget visual defects identifier is a combination of electronic gadget visual defects identification software, camera 7, and station interior lighting 2.

Camera 7 has a lens, a housing attachment of the station for automatic diagnostics of electronic gadgets, and a connector to plug to the electronic gadget visual defects identifier.

The electronic gadget spatial orientation device has a frame, a retractable mechanism, a swivel mechanism mount for the electronic gadget communicator, flaps 8, and swivel-clamp assembly 9.

The retractable mechanism has guides 10 fitted with actuators.

Flaps 8 have marks for the electronic gadget dimensioning and guides fitted with flap actuators.

Swivel-clamp assembly 9 has a rod pusher with an internal spring and a pusher actuator, electronic gadget retainer 11 fitted with a plate with parallel protrusions matching the end part of the electronic gadget, and a rotary mechanism having perpendicularly arranged spur gears provided with a drive gear actuator.

Note that the electronic gadget communicator is rigidly connected by the input plug to the electronic gadget, and is also connected by the output plug to the control unit; guides 10 of the retractable mechanism of the electronic gadget spatial orientation device are horizontally secured on housing 1 of the station, and flaps 8 of the electronic gadget spatial orientation device are secured in the electronic gadget spatial orientation device so that it is located longitudinally on flaps when placed for diagnostics and rigidly connected to the electronic gadget communicator output plug, which in turn is rigidly connected to the rotary mechanism of the electronic gadget communicator; the swivel-clamp assembly pusher is rigidly connected to the pusher actuator and electronic gadget retainer 11 and located so that protrusions of the electronic gadget retainer plate, placed on its end, are parallel and at the same level with the corresponding end part of the electronic gadget, when it is placed on flaps; flaps 8 are rigidly connected to flap guides and actuators arranged so that when an electronic gadget is placed in the station housing for automatic diagnostics, they are aligned with the output plug of the electronic gadget communicator, which is rigidly connected to the rotary mechanism of the electronic gadget communicator, and when the electronic gadget interacts with swivel-clamp assembly 9, flaps 8 are located on directly opposed side ends of the electronic gadget without contacting it; meanwhile the rotary mechanism having perpendicularly arranged spur gears, is connected to the swivel-clamp assembly pusher and the drive gear actuator; guides 6 of the stylus positioning unit are fastened on housing 1 in the plane parallel to flaps 8, and the stylus is rigidly fixed in stylus mount 5 rigidly connected to guides 6 of the stylus positioning unit and the stylus positioning unit actuators so that its tip is directed towards the electronic gadget located in the electronic gadget spatial orientation device; camera 7, by means of housing attachment 1 of the station for automatic diagnostics of electronic gadgets, is fastened so that its lens field of view covers the entire electronic gadget located in the electronic gadget spatial orientation device; station interior lighting 2 are fastened on housing 1 attachment of the station for automatic diagnostics of electronic gadgets so that its light is emitted to the electronic gadget located in the electronic gadget spatial orientation device; all the listed functional elements are connected to the control unit by means of transmitting cables.

The group of inventions operates as follows.

An electronic gadget diagnostic program is selected in the control unit of the station for automatic diagnostics of electronic gadgets by means of input/output tool 3. When starting the station, the retractable mechanism actuator of the electronic gadget spatial orientation device is activated on command from the control unit, sliding it out of station housing 1.

An electronic gadget is connected to the control unit by means of the electronic gadget communicator and is placed on flaps 8 of the electronic gadget spatial orientation device, being secured between the output plug of said device and retainer 11 of swivel-clamp assembly 9.

On command from the control unit, the pusher actuator of swivel-clamp assembly 9 is activated, the electronic gadget is locked by the electronic gadget retainer with the plate with parallel protrusions matching the end part of the electronic gadget.

On command from the control unit, the retractable mechanism actuator of the electronic gadget spatial orientation device is activated, sliding it out of station housing 1.

On command from the control unit, the actuators of flaps 8 guides are activated, flaps 8 rotate around the guides axis and move towards the plane parallel to side panels of housing 1 of the station for automatic diagnostics of electronic gadgets.

On command from the control unit, the electronic gadget hardware defects identifier is activated, the electronic gadget hardware defects identification software is started, electronic signals are sent and received from the electronic gadget by the electronic gadget communicator to assess operability of the electronic gadget hardware components, the electronic gadget camera is started, the mark focusing test is carried out.

On command from the control unit, the stylus positioning unit is activated, the stylus is moved along guides 6 using actuators so that its tip mechanically interacts with the electronic gadget display by moving the stylus rod and compressing or decompressing the springs attached thereto. The stylus applies varying pressure on the electronic gadget display, electronic signals containing information on the location, number, and strength of presses received from the stylus are transmitted to the control unit via the electronic gadget hardware defects identifier connector. In this case, electronic signals are transmitted from the electronic gadget to the control unit using the electronic gadget communicator. These signals contain information on the received presses location, number, and strength.

On command from the control unit, the stylus positioning unit is activated, then the stylus is moved to its home position by means of actuators.

On command from the control unit, the electronic gadget visual defects identifier is activated, the electronic gadget visual defects identification software is started, camera 7 and station interior lighting 2 are activated.

On command from the control unit, the swivel-clamp assembly actuator gears are activated, which rotates the swivel-clamp assembly pusher with the electronic gadget fixed therein 0 to 360 degrees around the swivel-clamp assembly pusher axis in the range of camera lens 7. Camera 7 transmits electronic signals to the control unit.

The control unit computer module with embedded software compares the electronic signals received from the functional elements of the station for automatic diagnostics of electronic gadgets with a pre-recorded database, and the user is provided with information on the electronic gadget diagnostics by means of input/output tool 3.

The control unit computer module with embedded software compares the diagnosed electronic gadget parameter values with a pre-recorded database. Based on matches, the electronic gadget is assigned to one of the classes preset in the database, and the user is provided with information on the possible residual value of the electronic gadget that corresponds to a certain class.

On command from the control unit, electronic signals are sent to the electronic gadget to reset the electronic gadget system settings and internal memory to factory values.

On command from the control unit, actuators of flaps 8 guides are activated, flaps 8 rotate around the axis of guides and move towards the plane parallel to an electronic gadget, leaning against it.

When starting the station, the retractable mechanism actuator of the electronic gadget spatial orientation device is activated on command from the control unit, sliding it out of station housing 1.

On command from the control unit, the swivel-clamp assembly pusher actuator is activated, retainer 11 of the electronic gadget returns to its home position disconnecting with the electronic gadget.

This results in achieving a technical result, which is to increase the number of detectable visual defects of an electronic gadget by the station for automatic diagnostics of electronic gadgets, thereby providing a high degree of identification of the electronic gadget visual defects by the electronic gadget visual defects identifier.

1. A station for automatic diagnostics of electronic gadgets consists of a control unit to which an electronic gadget communicator, electronic gadget visual and hardware defects identification aids, and an electronic gadget spatial orientation device capable of moving the electronic gadget linearly relative to the electronic gadget visual and hardware defects identification aids are connected. The control unit has electronic gadget visual defects identification software. The station is distinguished by the fact that the electronic gadget spatial orientation device has been designed with a capability of the electronic gadget rotation relative to the electronic gadget visual and hardware defects identification aids.

2. As per claim 1, the station is distinguished by the fact that the electronic gadget hardware defects identifier has a stylus attached to the unit of the stylus positioning relative to the electronic gadget.

3. As per claim 2, the station is distinguished by the fact that the stylus has been designed to apply a successively varying degree of pressure to the electronic gadget.

4. As per claim 2, the station is distinguished by the fact that the stylus contains a casing with outer and inner movable rods inside, interacting with each other, and the inner rod is fixed in the cage, while its outer and inner ends are fitted with springs.

5. As per claim 1, the station is distinguished by the fact that the electronic gadget spatial orientation device has flaps.

6. A method of automatic diagnostics of electronic gadgets by the station for automatic diagnostics of electronic gadgets comprises positioning of an electronic gadget in the electronic gadget spatial orientation device of the station for automatic diagnostics of electronic gadgets, connecting the electronic gadget to the control unit of the station for automatic diagnostics of electronic gadgets via the electronic gadget communicator, moving the electronic gadget relative to the electronic gadget visual and hardware defects identification aids, and identifying the electronic gadget visual and hardware defects by the control unit. The method is distinguished by the fact that when the electronic gadget is moved relative to the visual and hardware defects identification aids by means of the electronic gadget spatial orientation device, the electronic gadget is rotated relative to the electronic gadget visual and hardware defects identification aids.

7. As per claim 6, the method is distinguished by the fact that the electronic gadget residual value is calculated by the control unit.
